(19) United States
(12) Patent Application Publication
(10) Pub. No.: US 2024/0024878 A1
(43) Pub. Date: Jan. 25, 2024

(54) FLUIDIC DEVICES WITH REACTANT INJECTION

(71) Applicant: HP Health Solutions Inc., Palo Alto, CA (US)

(72) Inventors: Paul Mark Haines, Corvallis, OR (US); John Michael Lahmann, Corvallis, OR (US); Kenneth James Faase, Corvallis, OR (US)

(73) Assignee: HP Health Solutions Inc., Palo Alto, CA (US)

(21) Appl. No.: 18/265,650

(22) PCT Filed: Dec. 8, 2020
(86) PCT No.: PCT/US2020/063738

§ 371 Date: Jun. 6, 2023

(51) Int. Cl. B01L 3/00

(52) U.S. Cl. CPC B01L 3/5085; B01L 2200/16; B01L 2300/0672

(57) ABSTRACT

A fluidic device can include interconnected volumes including a bulk fluid volume fluidically connected in series with a capillary volume to receive a density gradient column, a reservoir of a reconstitution buffer positioned outside the interconnected volumes, and a buffer inlet chamber to receive reconstitution buffer from the reservoir of reconstitution buffer. The fluidic device can also include a reactant chamber connected to the buffer inlet chamber by a fluid channel, wherein the reactant chamber contains a reactant, and a reactant injection channel connecting the reactant chamber to the capillary volume to inject the reconstitution buffer and reactant into the capillary volume.

### BACKGROUND

In biomedical, chemical, and environmental testing, isolating a component of interest from a sample fluid can be useful. Such separations can permit analysis or amplification of a component of interest. As the quantity of available assays for components increases, so does the demand for the ability to isolate components of interest from sample fluids. Fluidic devices can be used for these applications, among others. In some examples, microfluidic devices can be used to prepare and process samples with small volumes.

### BRIEF DESCRIPTION OF THE DRAWINGS

FIGS. 1A and 1B illustrate a cross-sectional and front view of an example fluidic device in accordance with the present disclosure;

FIGS. 2A and 2B illustrate an example reactant chamber in a fluidic device in accordance with the present disclosure;

FIGS. 3A-3B illustrate a cross-sectional and front view of another example fluidic device in accordance with the present disclosure;

FIGS. 4A-4B illustrate a cross-sectional and front view of an example fluid processing system in accordance with the present disclosure;

FIGS. 5A-5B illustrate a cross-sectional and front view of another example fluid processing system in accordance with the present disclosure;

FIGS. 6A-6H illustrate the use of an example fluid processing system for processing fluids in accordance with the present disclosure; and

FIG. 7 is a flowchart illustrating an example method of processing fluids in accordance with examples of the present disclosure.

### DETAILED DESCRIPTION

The present disclosure describes fluidic devices, fluid processing systems, and methods of processing fluids. These devices, systems, and methods can include a reservoir of a buffer that can be mixed with a reactant, and the mixture of the buffer and reactant can be injected into interconnected volumes. In certain examples, the fluidic devices can be sample preparation devices that can be used to prepare a biological sample. In particular, the fluidic devices can be used to separate a particular biological component from a biological sample and add a reactant to the biological component. Some reactants may be subject to degradation when the reactants are prepared in a solution for use in a particular chemical reaction. Certain types of reactants are kept in a more stable state, such as in a dry state, for longer periods of time. When such dry reactants are mixed with liquid to form a solution, the reactants may begin to degrade quickly. Accordingly, it can be useful to keep the liquid and the reactants separate until just before use. In the present disclosure, the liquid that is mixed with the reactant is referred to as a “buffer.” The buffer can simply be water in some examples, or the buffer can include other ingredients such as salts, surfactants, pH controlling compounds, and others. The ingredients in the buffer can be appropriate for mixing with the reactant when preparing the reactant to be used in a reaction. The particular devices and systems described herein can provide a convenient way to keep the buffer and reactant separate, and then to mix a precise volume of the buffer with reactant and then quickly inject the mixture into interconnected volumes where the mixture can be used in a chemical reaction. In certain examples, the fluidic devices, systems, and methods can be used for a specific process of preparing samples for a PCR (polymerase chain reaction) assay. PCR assays are processes that can rapidly copy millions to billions of copies of a very small nucleic acid sample, such as DNA or RNA. PCR can be used for many different application, included sequencing genes, diagnosing viruses, identifying cancers, and others. In the PCR process, a small sample of nucleic acid is combined with reactants that can form copies of the nucleic acid. Because the volumes of samples fluid and reactant involved in this process are very small, it can be beneficial to use small fluidic devices and systems such as those described herein. Additionally, PCR processes involve reactants (e.g., PCR master mix) that can degrade quickly when in a liquid solution. These reactants can often be kept as dried reactant pellets. The devices and systems described herein provide a convenient way to keep a buffer separate from a dried reactant pellet, while allowing the buffer to mix with and reconstitute the dried reactant pellet and then quickly dispense the mixture for use in a PCR assay. In further examples, the fluidic devices and systems described herein can be a part of an automated process, in which the nucleic acid can be separated from a biological sample and mixed with the PCR master mix reactants with limited human interaction. For example, the process of separating nucleic acids from the biological sample, reconstituting the PCR master mix reactants, and mixing the reconstituted reactants with the nucleic acid can be performed by an automated system.

In one example, a fluidic device includes interconnected volumes including a bulk fluid volume fluidically connected in series with a capillary volume to receive a density gradient column, a reservoir of a reconstitution buffer positioned outside the interconnected volumes, and a buffer inlet chamber to receive reconstitution buffer from the reservoir of reconstitution buffer. The fluidic device in this example also includes a reactant chamber containing a reactant that is connected to the buffer inlet chamber by a fluid channel, and a reactant injection channel connecting the reactant chamber to the capillary volume to inject the reconstitution buffer and reactant into the capillary volume. In some examples, the reactant can include dried PCR master mix reactants and the buffer can be a reconstitution buffer for reconstituting the dried PCR master mix reactants. In further examples, the fluid channel can connect the reactant chamber to the buffer inlet chamber such that buffer flows to the reactant chamber after the buffer flows into the buffer inlet chamber. In other examples, the fluid channel can connect to the buffer inlet chamber at a top portion of the buffer inlet chamber such that the buffer inlet chamber fills up to the top portion with the buffer before the buffer flows through the fluid channel to the reactant chamber. In still other examples, the fluidic device can also include a gas reservoir and a gas channel connecting the gas reservoir to the fluid channel to inject gas into the fluid channel to push buffer in the fluid channel and buffer in the reactant chamber with the reactant into the capillary volume, while bypassing buffer the buffer inlet chamber. In certain examples, the fluid channel can connect to the reactant chamber at a top portion of the reactant chamber and adjacent to a front face of the reactant chamber, and the reactant chamber can include a ramp formed along a wall of the reactant chamber leading from the fluid channel to a back face of the reactant chamber, and the ramp can form a sharp corner with the wall to draw buffer toward the back face by capillary flow. In some examples, the buffer inlet chamber and the reactant chamber can be formed as depressions in a surface of a solid device body, and a sealing layer can be placed over the surface of the solid device body to enclose the depressions. In a further example, the reservoir of buffer can be a flexible fluid-filled blister separated from the buffer inlet chamber by the sealing layer. In still further examples, a solid material can be included in the buffer inlet chamber to reduce available volume in the buffer inlet chamber, wherein the solid material is not soluble in the buffer. Any features of fluidic devices described herein can also be included in fluid processing systems and methods, in various examples.

The present disclosure also describes fluid processing systems. In one example, a fluid processing system includes interconnected volumes having a bulk fluid volume fluidically connected in series with capillary volume, a reservoir of a wash buffer positioned outside the interconnected volumes, and a first fluid injection opening in the interconnected volumes to inject the wash buffer into the interconnected volumes. The first fluid injection opening in this example is connected to the reservoir of the wash buffer. The system further includes a reservoir of a reconstitution buffer positioned outside the interconnected volumes, a buffer inlet chamber to receive reconstitution buffer from the reservoir of reconstitution buffer, a reactant chamber connected to the buffer inlet chamber by a fluid channel, wherein the reactant chamber contains a reactant, and a reactant injection channel connecting the reactant chamber to the capillary volume to inject the reconstitution buffer and reactant into the capillary volume. In some examples, the reactant can include dried PCR master mix reactants and the buffer can be a reconstitution buffer to reconstitute the dried PCR master mix reactants. In still further examples, the system can include a gas reservoir and a gas channel connecting the gas reservoir to the fluid channel to inject gas into the fluid channel to push reconstitution buffer in the fluid channel and reconstitution buffer in the reactant chamber with the reconstituted reactant into the capillary volume, while bypassing reconstitution buffer in the buffer inlet chamber. Any features of fluid processing systems described herein can also be included in fluidic devices and methods, in various examples.

The present disclosure also describes methods of processing fluids. In one example, a method of processing fluids includes injecting a reconstitution buffer from a reservoir into a buffer inlet chamber. The buffer inlet chamber in this example is connected to a reactant chamber by a fluid channel such that the reconstitution buffer flows to the reactant chamber after the reconstitution buffer flows into the buffer inlet chamber, and the reactant chamber in this example contains a reactant. The method further includes injecting the reconstitution buffer carrying the reactant into a capillary volume of interconnected volumes, wherein injecting the reconstitution buffer carrying the reactant occurs through a reactant injection channel fluidically connecting the reactant chamber to the capillary volume. In one example, the method can further include injecting a wash buffer into the interconnected volumes before injecting the reconstitution buffer into the buffer inlet chamber, and loading a sample fluid into the interconnected volumes above the wash buffer. The sample fluid can include magnetizing particles having a biological component bound thereto, and the sample fluid can have a lower density than the wash buffer. In other examples, the reconstitution buffer can displace gas from the buffer inlet chamber and the reactant chamber, and the gas can flow into the capillary volume and form a gas gap in the capillary volume.

It is noted that when discussing examples of fluidic devices, fluid processing systems, and methods described herein, such discussions can be considered applicable to one another whether or not they are explicitly discussed in the context of that example. Thus, for example, when discussing a reactant in a fluidic device, such disclosure is also relevant to and directly supported in the context of a fluid processing system or a method of processing fluids, and vice versa.

Terms used herein will have the ordinary meaning in the relevant technical field unless specified otherwise. In some instances, there are terms defined more specifically throughout the specification or included at the end of the present specification, and thus, these terms can have a meaning as described herein.

### Fluidic Devices

The present disclosure describes fluidic devices that include interconnected volumes to contain a fluid column, such as a density gradient column, and which allow a reactant to be introduced into the interconnected volumes by injecting a buffer through a reactant chamber and into the interconnected volumes. In more detail, the fluidic devices described herein can include a combination of a reservoir of a buffer, a buffer inlet chamber, and a reactant chamber. These can be connected in series so that the buffer can flow from the reservoir into the buffer inlet chamber, then from the buffer inlet chamber into the reactant chamber, and then from the reactant chamber into the interconnected volumes that may contain a density gradient column. The interconnected volumes can include a capillary volume and the reactant chamber can be connected specifically to the capillary volume so that the buffer and the reactant flow into the capillary volume.

Some types of reactants can have a short shelf life. In one example, PCR master mix reactants have a limited shelf life when the reactants are combined in an aqueous solution. However, these reactants can be dried through a process such as lyophilization to extend the shelf life of the reactants. PCT master mix reactants can be lyophilized and formed into a dry pellet that can be reconstituted by adding a reconstitution buffer. Therefore, in some examples, the buffer used in the fluidic devices described herein can be a reconstitution buffer for reconstituting a dried reactant.

In certain examples, the fluidic devices described herein can hold a dried reactant in a reactant chamber and a reconstitution buffer in a buffer reservoir. The buffer can be kept separate from the reactant until time of use. In many cases, the shelf life of the dried reactant can be maximized by keeping the reactant as dry as possible. Accordingly, the reactant can be sealed inside a reactant chamber within the fluidic device to keep the reactant away from moisture during storage. The fluidic devices can also be designed to deliver a precise amount of the reconstitution buffer to the reactant chamber to reconstitute the reactants. Therefore, the reconstituted reactants can have a precise concentration as desired for further processing. In some examples, the reconstitution buffer can flow into a buffer inlet chamber before flowing into the reactant chamber. If it is desired to adjust the volume of buffer delivered to the reactant chamber, then the buffer inlet chamber can be modified to have a different available volume. In some examples, a solid material can be placed into the buffer inlet chamber to occupy a portion of the interior volume of the buffer inlet chamber. This can displace the same volume of buffer, so that a larger amount of buffer is delivered to the reactant chamber instead of remaining in the buffer inlet chamber. This can provide a simple way to adjust the amount of buffer delivered to the reactant chamber without redesigning the buffer inlet chamber or the reservoir of buffer.

In further examples, the fluidic device can be designed to allow the reactant to mix with the desired volume of buffer, and then the desired volume of buffer mixed with the reactant can be ejected from the fluidic device. In certain examples, any excess buffer that is present in the buffer inlet chamber can remain in the buffer inlet chamber after the desired volume of buffer mixed with the reactant has been ejected. This can be accomplished using a gas channel to conduct forced gas to push the desired volume of buffer and the reactants out of the fluidic device. An example of such a gas channel is described in more detail below and shown in the figures. In some examples, the buffer inlet chamber can be connected to the reactant chamber by a fluid channel. The gas channel can connect to the fluid channel between the buffer inlet chamber and the reactant chamber. When a gas, e.g., air, is forced through the gas channel, the gas can flow into the reactant chamber, pushing the buffer and reactants in the reactant chamber out of the fluidic device. However, the gas can bypass the buffer that is in the buffer inlet chamber.

The reactant chamber can also be designed to ensure complete reconstitution of the dried reactant. At small scales, forces due to surface tension can become as significant as or more significant than other forces such as pressure, gravity, etc. on the buffer. In some cases, the buffer can tend to wet surfaces that include sharp interior corners due to capillary forces. In certain examples, the reactant chamber can include a ramp surface along an interior wall of the chamber, which forms a sharp corner with the wall of the chamber. The sharp corner can tend to draw the buffer fluid along the ramp. The ramp can begin at or near the fluid channel where buffer flows into the chamber, and the ramp can lead to another wall of the chamber. For example, the fluid channel can connect to the reactant chamber near a front wall of the reactant chamber, and the ramp can lead back to the back wall of the reactant chamber. This can cause the buffer fluid to flow to both the front and back interior faces of the reactant chamber. If the reactant is in the form of a dry pellet, then the buffer fluid is encouraged to flow all around the front and back of the pellet to fully reconstitute the pellet.

Although many of the examples described herein include dried reactants, such as dried PCR master mix reactants, the fluidic devices described herein can be used with a variety of other reactants, including solid reactants that are soluble in the buffer, solid reactants that can be dispersed in the buffer, liquid reactants, and so on.

The present disclosure includes several figures illustrating specific examples of the technologies described herein. These figures show fluidic devices and fluid processing systems that include a variety of components arranged is specific ways depending on the purpose and function of the particular examples depicted. Although the figures illustrate examples that implement the technologies described herein, these examples also include many features that are optional, which may be changed or removed depending on the particular example. Accordingly, it is understood that the technologies described herein are not limited by the examples shown in the figures

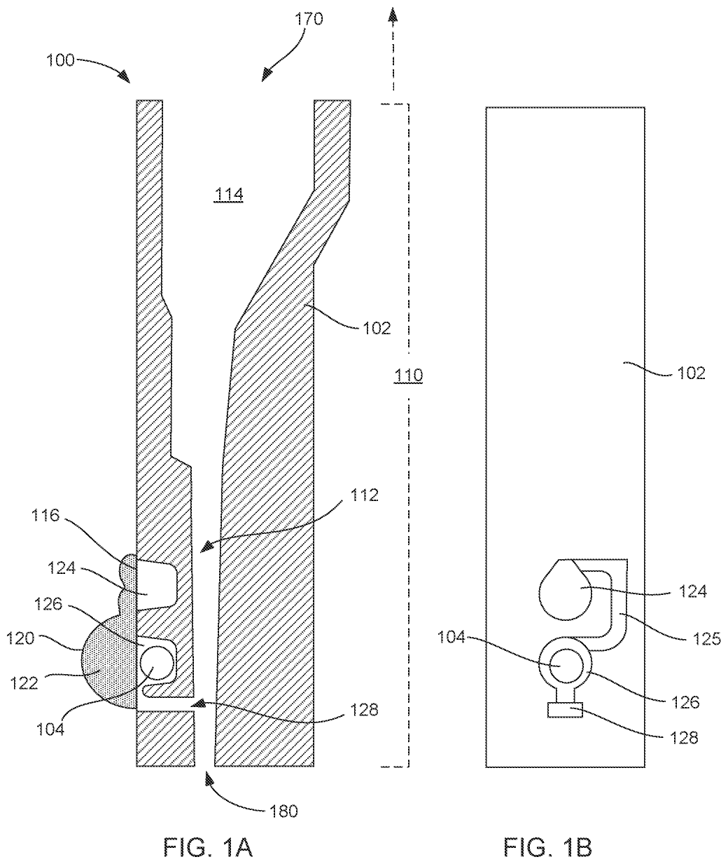

FIG. 1A shows a cross-sectional side view of an example fluidic device 100 in accordance with the present disclosure. The fluidic device includes a solid device body 102. Interconnected volumes 110 is formed in the solid device body. The interconnected volumes include a capillary volume 112 and a bulk fluid volume 114. A reservoir 120 of a buffer 122 is positioned outside the interconnected volumes. A buffer inlet chamber 124 is also formed in the solid device body. The buffer inlet chamber can receive buffer from the buffer reservoir. In this particular example, the buffer reservoir is a flexible blister that is separated from the buffer inlet chamber by a sealing layer 116. Pressing on the blister with sufficient force can rupture the sealing layer so that the buffer flows into the buffer inlet chamber. The buffer inlet chamber is connected to a fluid channel that leads to a reactant chamber 126. The reactant chamber holds a reactant 104, which in this example is in the form of a dry pellet. The reactant chamber is also connected to a reactant injection channel 128 that leads to the capillary volume. The buffer and the reactant can be injected into the capillary volume through the reactant injection channel.

FIG. 1B shows a front view of the solid device body 102 in order to clarify the design and placement of the chambers and channels that are formed in the solid device body. The front surface of the solid device body is covered by the sealing layer and the blister containing the buffer fluid. The buffer inlet chamber 124 is located under the blister reservoir (not shown). The buffer inlet chamber is connected to the reactant chamber 126 by a fluid channel 125. The reactant 104 pellet is held inside the reactant chamber. In this example, the reactant pellet can be placed into the reactant chamber before the sealing layer is placed over the device body. Thus, the sealing layer can enclose the reactant in the reactant chamber.

In the example shown in FIGS. 1A and 1B, the fluidic device is designed so that the buffer can flow from the reservoir into the buffer inlet chamber first, and then once the buffer inlet chamber has filled to the top, then the buffer can flow through the fluid channel into the reactant chamber. Therefore, the device can deliver a precise volume of buffer into the reactant chamber. The volume of buffer that is delivered can be the volume of buffer that remains in the reservoir after the buffer inlet chamber has been filled. In some examples, the volume of buffer that is delivered to the reactant chamber can be changed by changing the volume of the buffer inlet chamber. Decreasing the volume of the buffer inlet chamber can increase the volume of buffer that is delivered to the reactant chamber. Similarly, increasing the volume of the buffer inlet chamber can decrease the volume of buffer that is delivered to the reactant chamber. The volume of the buffer inlet chamber can be increased or decreased by changing the design of the chamber when the chamber is formed in the solid device body (such as by molding, machining, 3D printing, or another manufacturing process). Additionally, the volume of the buffer inlet chamber can be decreased easily by adding a solid material into the buffer inlet chamber to occupy a portion of the volume inside the chamber. Placing a solid material in the buffer inlet chamber in this way can provide another way to adjust the volume of buffer that is delivered to the reactant chamber without changing the design of the buffer inlet chamber itself. In some cases, adjusting the volume of buffer delivered to the reactant chamber can be useful to find a volume that achieves a desired concentration of the reactant, or to achieve a desired volume of buffer/reactant mixture to be added to other reactants further on in fluid processing.

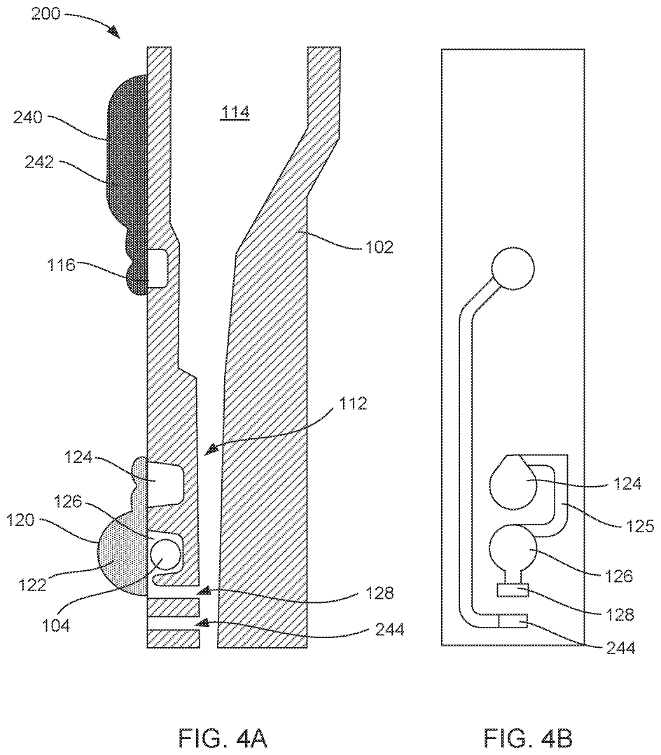

FIGS. 1A-3B herein depict various portions of example devices and FIGS. 4A-6H herein depict various portions of example systems. However, it is noted that the devices and systems shown and described herein can be interchangeable with respect to structural components shown in the various examples. Furthermore, the devices and systems can include other structures not shown that may be present upstream and/or downstream from the illustrated structures. For example, as shown in FIGS. 1A and 1B, these devices and systems can be part of a sample preparation cartridge module that includes a biological sample input 170 and output 180. For example, the sample preparation cartridge module may include interconnected volumes arranged in series between the input and output in a linear direction. The various volumes may include, for example, the bulk fluid volume 114 and the capillary volume 112. However, there may be other volumes present above or below these portions, or which are included as part of these portions, e.g., sub-volumes. For example, the bulk fluid volume may include a mixing chamber (not shown) connected to the biological sample input to contain and mix a composition comprising a biological sample and a particulate substrate. In this example, the mixing chamber may reside as part of the bulk fluid volume separated by a displaceable membrane, e.g., rupturable, piercable, puncturable, removable, etc., or other barrier or valve. In other examples, the mixing chamber may reside as part of the entire bulk fluid volume. The capillary volume, on the other hand, may include a fluidic isolation chamber connected to the mixing chamber downstream of the mixing chamber to separate particulate substrate and a biological component from the biological sample. The separation may be by the introduction of a non-newtonian fluid at a location into the interconnected volumes, or in other examples, the introduction of a gas, e.g., air bubble in the capillary volume to separate the mixing chamber from the fluidic isolation chamber, as described in greater detail hereinafter.

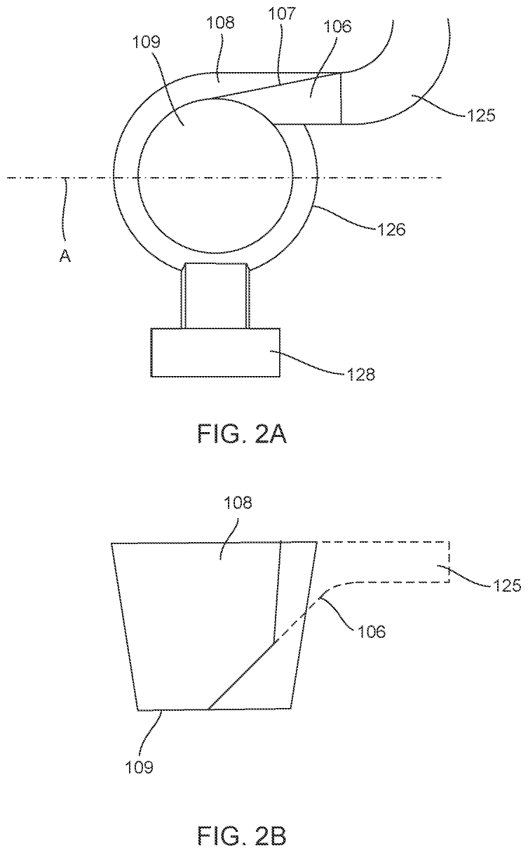

FIG. 2A shows a closer view of the reactant chamber 126. In this example, the reactant chamber includes a ramp 106 formed along a wall 108 of the reactant chamber. The ramp leads from the fluid channel 125 to a back face 109 of the reactant chamber. The fluid channel connects to the reactant chamber at a top portion of the reactant chamber and adjacent to a front face of the reactant chamber. Thus, the ramp leads from a location near the front face of the reactant chamber to the back face of the reactant chamber. A sharp corner 107 is formed between the ramp and the wall of the reactant chamber. This sharp coiner can draw the buffer fluid along the ramp by capillary flow. Buffer that flows in from the fluid channel can be drawn along the ramp toward the back face of the reactant chamber. As used herein, the terms “front” and “back” are used for convenience and can refer to any faces of the reactant chamber that are across from one another. In this example, the front face refers to the face of the reactant chamber that is formed from the sealing layer when the sealing layer is placed over the solid device body. Accordingly, the front face is not shown in FIGS. 2A and 2B because the sealing layer is not shown. In this example, the back face is the face of the chamber that is opposite from the front face. FIG. 2B shows a cross-sectional view of the reactant chamber, with the cross-section taken along the plane indicated as “A” in FIG. 2A. Portions of the structure that are obscured by solid device body in this view are shown as dashed lines. This figure shows that the floor of the fluid channel 125 curves and begins to slope to form the ramp 106, which extends along the wall 108 of the chamber and leads to the back face 109 of the chamber.

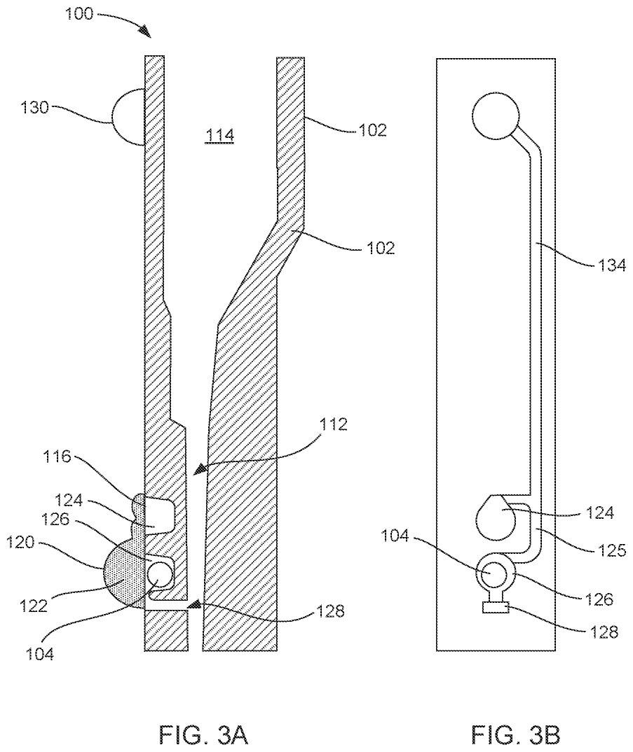

Another example fluidic device 100 is shown in FIGS. 3A-3B. As in the example of FIGS. 1A-1B, as shown in FIG. 3A, this fluidic device includes interconnected volumes 110 formed in a solid device body 102, or vessel, e.g., modular vessel, unitary vessel, etc. The interconnected volumes include a capillary volume 112 and a bulk fluid volume 114. A reservoir 120 of a buffer is positioned outside the interconnected volumes. A buffer inlet chamber 124 can receive buffer from the reservoir. A reactant chamber 126 is connected to the buffer inlet chamber by a fluid channel 125. A reactant injection channel 128 connects the reactant chamber to the capillary volume. This example also includes a gas reservoir 130 and a gas channel 134. FIG. 3B shows a front view of the solid device body, showing how the gas channel is formed in the solid device body to connect the gas reservoir to the fluid channel. A gas, e.g., air, can be injected from the gas reservoir into the fluid channel through the gas channel to push buffer in the fluid channel and buffer in the reactant chamber, with any reactant that has mixed with the buffer, into the capillary volume. The gas reservoir can be a flexible blister as with the buffer reservoir. Because the gas flows from the gas channel that connects to the fluid channel, the gas bypasses the buffer that is in the buffer inlet chamber. The gas pushes buffer and reactants out of the reactant chamber, but any buffer that is in the buffer inlet chamber remains in place. In some examples, the gas reservoir can be used to eject the buffer and reactant from the fluidic device after the reactant has had sufficient time to reconstitute in the buffer.

In some examples, the interconnected volumes carry a fluid column, such as a density gradient column, the terms “density gradient” can be used in various contexts herein but can refer to the ability of multiple fluids to remain separated in layers due to their density difference (with denser fluids being positioned vertically lower along the column). Thus, there can be multiple fluids that are phase separated, but are still in direct contact at a fluid interface, referred to herein as a “density-differential interface,” which is descriptive of the interface being present as a result of the density difference. Accordingly, a density gradient column can include multiple fluids of different density that are in contact at a density-differential interface.

In further examples, the interconnected volumes can include a capillary volume. The capillary volume can be a portion having a narrowed diameter in which capillary forces can be significant. In some examples, capillary force can allow a fluid having a lower density to occupy a position below a fluid having a higher density. For example, a fluid with a lower density can be present in the capillary volume, and capillary forces can maintain the lower density fluid in the capillary volume even when a higher density fluid is present above the capillary volume. The terms “capillary force” or “capillary force-supported gradient” can refer to fluid interfaces that are not maintained by density difference, but rather, the fluids of immediately adjacent layers can have different densities, but less dense fluids can be positioned below denser fluids. Less dense fluids can be constrained within the capillary volume due to the surface tension of the fluids at the fluid interface and the interaction of the fluids with walls of the capillary volume. The interface between such fluids can be a “capillary force-supported interface.”

When describing multiple fluids herein, the fluids may be referred to as a “first,” “second,” “third,” etc., fluid so that the fluids can be described relative to one another and for clarity in describing for understanding the disclosure. However, these terms should not be considered to be limiting. Accordingly, a “first fluid” and “second fluid” and so on can be interchangeable as is convenient for describing a particular example. The terms “first,” “second,” and so on do not imply a particular order, position, or hierarchy of the fluids.

When multiple fluids of different densities are present along the density gradient column, adjacent fluids can have a density difference that is calculated as the difference between the density of the denser fluid and the density of the lighter fluid. Example density differences between fluids of the density gradient column can be from 50 mg/mL to 3 g/mL, from 100 mg/mL to 3 g/mL, from 500 mg/mL to 3 g/mL or from 1 g/mL to 3 g/mL. The “fluid density” can be measured by calibrating a scale to zero with the container thereon and then obtaining the mass of the fluid, e.g., liquid, in grams. The volume of the measure mass can then be determined using a graduated cylinder. The density is then calculated by dividing the mass by the volume to provide the fluid density (g/mL).

In further detail regarding density gradient columns, in various examples there can be any of a number of fluids in the column, e.g., two fluids, three fluids, four fluids, etc., vertically arranged. Thus, the column can also be referred to as a “multi-fluid density gradient” column. The fluids may or may not be positioned 90 degrees from horizontal relative to one another, e.g., they may or may not be stacked or layered directly on top of one another but may be in a vessel angled at less than 90 degrees from horizontal, but the interface between the fluids can be horizontal. Thus, the term “vertically layered” refers to fluids that are on top of one another relative to a force such as gravity or centripetal force in a centrifuge with a horizontal interface extending there between, even if they are not fully directly on top of one another. A multi-fluid density gradient column does not include fluid layers where an additional substance may be used to separate one fluid layer from another. In a density gradient column, there are two or more fluids that are not separate by anything at their interface other than by separation that occurs naturally by densities of the two respective fluids. Fluid layers of the multi-fluid density gradient portion can be phase separated from one another based on fluidic properties of the various fluids, including density of the respective fluids along the column. The greater or higher the density of a fluid, relative to other fluids in the column, the closer to the bottom of the column the fluid will be located as defined or established by gravity. For example, the first fluid layer can have a first density and can form a first fluid layer of the multi-fluid density gradient portion. The second fluid layer can have a second density that can be greater than a density of the first fluid layer and can form a second fluid layer of the multi-fluid density gradient portion beneath the first fluid layer. An additional fluid layer(s), e.g., third, fourth, etc., can have a third, fourth, etc., density that can be greater than a density of the previous fluid layer and can form a third, fourth, etc., fluid layer of the multi-fluid density gradient portion beneath the second fluid layer. As a note, this is not the case for the “capillary force-supported interface.” In that instance, the surface tension of the fluid relative to the size and material of the vessel provides the ability to put less dense fluids beneath fluids of greater density.

In some examples, a density of a fluid in a fluid layer can be altered using a densifier. Example densifiers can include sucrose, polysaccharides such as FICOLL™ (commercially available from Millipore Sigma (USA)), C₁₉H₂₆I₃N₃O₉ such as NYCODENZ® (commercially available from Progen Biotechnik GmbH (Germany)) or HISTODENZ™, iodixanols such as OPTIPREP™ (both commercially available from Millipore Sigma (USA)), or combinations thereof. In further detail, example additives that can be included in the fluid layers can include sucrose, C1-C4 alcohol, e.g., isopropyl alcohol, ethanol, etc., which can be included to adjust density, and/or to provide a function with respect to biological components or materials to pass through the column.

In certain examples, the fluidic devices described herein can include interconnected volumes that includes a bulk fluid volume and a capillary volume. The bulk fluid volume can be upstream of the capillary volume. For example, when the fluidic device is in operation, a density gradient column included therein and can be oriented vertically and the bulk fluid volume can be above the capillary volume. The bulk fluid volume can be wider and can have a larger cross-section than a cross-section of the capillary volume. The bulk fluid volume can include a conical chamber, a cylindrical chamber, or a combination thereof. A cross-section of the chamber can be round, square, triangle, rectangle, or other polygonal in shape. In some examples, the bulk fluid volume can have a diameter at the widest cross-section of from 5 mm to 5 cm, 7 mm to 4 cm, 8 mm to 3 cm, or 8 mm to 2 cm. The bulk fluid volume can be where a majority of the fluid of the density gradient column resides. The bulk fluid volume can connect to the capillary volume at a capillary junction.

The capillary volume can have a smaller cross-section than a cross-section of the bulk fluid volume. The capillary volume can be an elongated tubular region and can have a round, square, triangle, rectangle, or other polygonal cross-section. In some examples, the capillary volume at the widest cross-section can have an interior opening diameter of from 0.1 mm to 4 mm, 0.2 mm to 3 mm, 0.5 mm to 4 mm, or 1 mm to 3 mm. The capillary volume may be tapered. For example, the capillary can be tapered and can have an interior channel diameter of 4 mm at one end to an interior channel diameter at the opposite end of 1 mm. For example, the capillary can be tapered from an interior channel diameter of 3 mm at one end to an interior channel diameter at the opposite end of 1 mm, or from 2 mm at one end to an interior channel diameter at the opposite end of 1.5 mm, or from 2 mm at one end to an interior channel diameter at the opposite end of 1 mm.

The interconnected volumes can be formed in a solid device body. In some examples, the solid device body can be made of various polymers (e.g. Polypropylene, TYGON, PTFE, COC, others), glass (e.g. borosilicate), metal (e.g. stainless steel), or a combination of materials. Additionally, the capillary volume can also be formed in the same solid device body, or the capillary volume can be made from a different material. In some examples, the capillary volume can be formed from materials used in various microfluidic devices, such as silicon, glass, SU-8, PDMS, a glass slide, a molded fluidic channel(s), 3-D printed material, and/or cut/etched or otherwise formed features. The solid device body, or vessel, can be monolithic or may be a combination of components fitted together, thus indicating that interconnected volumes may be defined by a unitary device with multiple regions or may be defined by a modular device where vessel components are joined together to form the interconnected volumes.

The interconnected volumes can be operable to receive fluids, such as a sample fluid, a lysis buffer, a wash buffer, a gas, a reconstituted reagent, and the like. Fluids can be arranged along the density gradient column in layers and individual layers can be phase separated from one another at fluid interfaces. In some examples, the phase separation can be based on fluidic properties of the various fluids, including density of the respective fluids along the column. Fluid layers can be in fluid communication with adjoining fluid layers.

In the bulk fluid volume, the greater or higher the density of a fluid, relative to other fluids in the column, the closer to the bottom of the bulk fluid volume the fluid will be located. For example, when arranged vertically, a first fluid layer having a first density can form the first layer of the density gradient column. The second fluid layer having a second density greater than a density of the first fluid layer can form a second fluid layer of the density gradient column. The third fluid layer having a third density greater than a density of the second fluid layer can form a third fluid layer of the density gradient column and the like. In one example, the density gradient column can include a sample fluid positioned on top of a wash buffer, wherein the wash buffer has a greater density than the sample fluid.

In the capillary volume, a surface tension of the fluid relative to the size and material of the vessel can provide the ability to position less dense fluids beneath fluids of greater density. In some examples, a separation gas bubble can be formed in the capillary volume where a fluid of the density gradient column resides. The separation gas bubble can become trapped in the capillary volume due to the surface tension in the capillary volume. A fluid having a density that is less than the density of fluids above the separation gas bubble can be located below the separation gas bubble. For example, the fluid that is above the gas bubble can include densifiers, as described above, and the fluid below the gas bubble can be free of densifiers so that the fluid above the gas bubble has a higher density. In various examples, the density difference between the fluid above the gas bubble and the fluid below the gas bubble can be from 50 mg/mL to 3 g/mL, from 100 mg/mL to 3 g/mL, from 500 mg/mL to 3 g/mL or from 1 g/mL to 3 g/mL. The separation gas bubble can prevent intermixing despite the density difference.

Although separation gas bubbles formed in the capillary volume can separate fluid along the density gradient column (separate two fluids, or bifurcate a single fluid along the fluid column), in some examples this separation can be difficult to maintain because the gas bubbles can be fragile and may easily be lost because the gas bubble can quickly float up through fluid in the bulk fluid volume above. In a particular example, the fluidic device can be a fluid processing device for mixing a biological sample with reagents. In this particular example, the fluid in the capillary volume can include the biological sample and reagents, and the fluid in the bulk fluid volume can include a wash buffer. The wash buffer and biological sample with reagents referred to here are described in more detail in the examples of fluid processing systems below. The wash buffer may be separated from the sample and reagents by a gas bubble, such as a gas bubble. This particular device can also include a cap covering the bottom end of the capillary volume. The cap can be unsealed and the sample and reagents can be ejected out the bottom of the capillary volume. However, the uncapping and ejecting process can generate back pressure in the capillary volume, which can often push the gas bubble out of the capillary volume, which can break the separation between the wash buffer and the sample/reagent mixture. Because the sample and reagent mixture can be less dense than the wash buffer, this can result in the sample and reagent mixture quickly rising up into the bulk fluid volume of the column, which can ruin the preparation of the sample. In certain examples, a more robust separation between the fluids can be implemented using a non-newtonian plugging fluid. The non-newtonian plugging fluid can be a fluid that can be injected into the capillary volume, which can have a sufficient high viscosity to partition fluids above the non-newtonian plugging fluid from fluids below the non-newtonian plugging fluid. In certain examples, a combination of a gas bubble and a plug of non-newtonian plugging fluid can be used to separate the fluid in the bulk fluid volume from fluid in the capillary volume.

The viscosity of the non-newtonian plugging fluid can be sufficient to separate fluids above the plug of non-newtonian plugging fluid from fluids below the plug of non-newtonian. This can include holding a pressure head of the fluids above the non-newtonian fluid when the interconnected volumes is oriented vertically. In some examples, the viscosity of the non-newtonian plugging fluid can be effectively infinite up to a threshold stress. In these examples, the non-newtonian plugging fluid can act as a rigid body when the stress on the fluid is below the threshold. In other examples, the non-newtonian plugging fluid can have a viscosity that is sufficient to support the fluids above the plug for an amount of time that can allow fluid below the plug to be ejected from the device without mixing the fluid above the plug. In certain examples, the non-newtonian fluid plug can have a viscosity of greater than 5,000 centipoise, or greater than 10,000 centipoise, or greater than 15,000 centipoise, or greater than 20,000 centipoise.

In certain examples, the non-newtonian plugging fluid can be grease-based. As used herein, “grease” can refer to a dispersion of a thickening agent in a liquid lubricant. Greases can often act as a solid when not under stress or when low stress is applied. However, greases can flow as a viscous fluid when higher stresses are applied. This can allow the grease to be injected into the interconnected volumes to form a plug, and then the plug can act as a solid when under low stress. In various examples, the non-newtonian plugging fluid can include a mineral oil-based grease, a vegetable oil-based grease, a petroleum oil-based grease, a synthetic oil-based grease, a semi-synthetic oil-based grease, a silicone oil-based grease, or a combination thereof. Examples of greases that can be used can include greases available under the trade names ANTI-SEIZE TECHNOLOGY™ (A.S.T. Industries, Inc., USA), CITGO® (Citgo Petroleum Corporation, USA), JET-LUBE® (Whitmore Manufacturing LLC, USA), KRYTOX™ (Chemours Company, USA), MOBIL® (Exxon Mobil Corporation, USA), MYSTIK® (Mystik Lubricants, USA), SPRAYON® (Sprayon, USA), and SUPER LUBE® (Super Lube, USA).

In some examples, a non-newtonian plugging fluid can be injected into the capillary volume from a reservoir. In further examples, fluidic devices can also include reservoirs of other fluids that are used in the fluidic device. Reservoirs can be positioned outside of the density gradient column. In various examples, the reservoirs can be fluidically connected to the interconnected volumes via openings, microchannels, inlets, etc., through the solid device body, which can be operable to permit dispensing of fluid from the reservoir into the interconnected volumes.

Reservoirs can vary in type. For example, a reservoir can be a chamber, a channel, a flexible blister pack, a syringe, a bag, a balloon, or a combination thereof. In one example, a reservoir can be a flexible blister pack that when pushed, can open and force contents out of the reservoir and into the interconnected volumes where the density gradient column resides. In some examples, the reservoir can include a sealing layer that can maintain separation of contents in the reservoir and the density gradient column until the sealing layer is broken, pierced, removed, or otherwise displaced. Breaking the sealing layer may allow contents of the reservoir to be released therefrom. In some examples the fluidic device can include a sharp point located near the sealing layer so that the sharp point can puncture the sealing layer when pressure is applied to the blister. In other examples, the blister pack can be designed to release fluid from the blister in other ways. In one example, the sealing layer can be easy to rupture so that the sealing layer can rupture without a sharp point to puncture the sealing layer. In another example, a sharp point can be formed inside the blister, such as on the exterior flexible wall of the blister, so that the sharp point can puncture the sealing layer from the inside of the blister when pressure is applied to the blister.

Reservoirs can be sized and shaped to contain a fluid, a reagent, or a combination thereof. Types of reservoirs can include the buffer reservoir, a non-newtonian plugging fluid reservoir, a wash buffer reservoir, a gas reservoir, a dry reagent reservoir, or a combination thereof. The buffer reservoir can be sized to hold an appropriate volume of buffer fluid. In some examples, the fluidic device can include the buffer fluid inside the reservoir. Additionally, the reservoir can be connected to a buffer inlet chamber and a reactant chamber as explained above.

### Fluid Processing Systems

The present disclosure also describes fluid processing systems. Fluid processing systems can include fluidic devices as described above together with additional components. In certain examples, fluid processing systems can include a reservoir of wash buffer and an opening for injecting the wash buffer into the interconnected volumes. The systems can also include a reservoir of buffer, a buffer inlet chamber, and a reactant chamber as described above.

In a certain example, a fluid processing system can include interconnected volumes having a capillary volume. A reservoir of a wash buffer can be positioned outside the interconnected volumes. A first fluid injection opening can be in the interconnected volumes. The first fluid injection opening can be connected to the reservoir of the wash buffer so that the wash buffer can be injected into the interconnected volumes through the opening. A reservoir of a reconstitution buffer can also be positioned outside the interconnected volumes. A buffer inlet chamber can receive reconstitution buffer from the reservoir. A reactant chamber can be connected to the buffer inlet chamber by a fluid channel. The reactant chamber can contain a dried reactant. A reactant injection channel can connect the reactant chamber to the capillary volume to inject the reconstitution buffer and reconstituted reactant into the capillary volume. In certain examples, the interconnected volumes can contain a density gradient column as described above.

The fluid processing systems can also include additional fluid reservoirs. For example, a fluid processing system can include a reservoir of reconstitution buffer, a reservoir of a wash buffer, a reservoir of gas, e.g., air, and a reservoir of a non-newtonian plugging fluid. In some examples, a reservoir of a fluid in the fluid processing system can be referred to as a “reservoir of first fluid.” In some examples, the first fluid can be a wash buffer. The wash buffer can be a liquid that can be used to wash a biological sample. Biological samples can include DNA, RNA, proteins, viruses, antibodies, or a variety of other biological materials. In one particular example, the fluid processing system can be used to detect a virus and the biological sample can include nucleic acids such as DNA or RNA extracted from the virus. The nucleic acids can be extracted by lysing viruses, which can result in a lysate solution containing the viral nucleic acids in addition to fragments of lysed viruses and other materials. In this example, magnetizing particles can be included in the lysate. The magnetizing particles can be surface activated for binding to the nucleic acids. Thus the nucleic acid molecules can bind to the surface of the magnetizing particles. Magnets can be used to move the magnetizing particles through a layer of wash buffer. Any virus fragments and other materials that may be adhering to the magnetizing particles can be washed off by the wash buffer. Thus, the wash buffer can be a liquid that can wash off these materials while also being safe for the nucleic acids or other biological samples. In some examples, the wash buffer can include ingredients such as water, salts, surfactants, buffering agents to maintain pH, and others. In certain examples, the wash buffer can include a densifier as described above to increase the density of the wash buffer. Thus, the wash buffer can be denser than the lysate solution, allowing the lysate solution to be added as a layer on top of the wash buffer.

Turning to the reconstitution buffer, the reconstitution buffer can be used to reconstitute a dried reactant and then the reconstitution buffer and the reconstituted reactant can be injected into the capillary volume. In one example, the reactant can include PCR (polymerase chain reaction) master mix reactants. This type of reactant can be useful to mix with a sample containing nucleic acids in order to perform nucleic acid amplification or similar processes. PCR master mix reactants can include a mixture of multiple compounds that are used in a PCR assay. These compounds can include DNA polymerase, nucleoside triphosphate, deoxyribose nucleoside triphosphate, magnesium chloride, magnesium sulfate, template DNA, forward primer, reverse primer, tris hydrochloride, potassium chloride, and others. In certain examples, the reactant can be a lyophilized PCR master mix. Examples of commercially available PCR master mixes include TITANIUM TAQ ECODRY™ premix, ADVANTAGE 2 ECODRY™ premix (available from Takara Bio, Inc. Japan); Lyophilized Ready-to-Use and Load PCR Master Mix (available from Kerafast, Inc., USA); MAXIMO™ Dry-Master Mix (available from GenEon Technologies, USA), and others. In some examples, the reactant can be a dried reactant that includes all ingredients for the process other than water. In such examples, the reconstitution buffer can simply be water. In other examples, the reconstitution buffer can include additional ingredients, such as salts, surfactants, buffering agents to maintain pH, and others.

FIGS. 4A-4B show one example fluid processing system 200. FIG. 4A shows a cross-sectional side view of the system, and FIG. 4B shows a front view of the solid device body 102, as in the examples above. This system includes interconnected volumes 110 formed in the solid device body. The interconnected volumes include a capillary volume 112 and a bulk fluid volume 114. A reservoir 120 of reconstitution buffer 122 is positioned outside the interconnected volumes. A buffer inlet chamber 124 and a reactant chamber 126 are also formed in the solid device body. The reactant chamber holds a dried reactant 104. The reactant chamber is also connected to a reactant injection channel 128 that leads to the capillary volume. This fluid processing system also includes a reservoir 240 of wash buffer 242. A first fluid injection opening 244 is positioned in the interconnected volumes to inject the wash buffer into the interconnected volumes. The first fluid injection opening is connected to the reservoir of the wash buffer. In this particular example the first fluid injection opening is positioned along the capillary volume, and the reactant injection channel connects to the capillary volume above the first fluid injection opening.

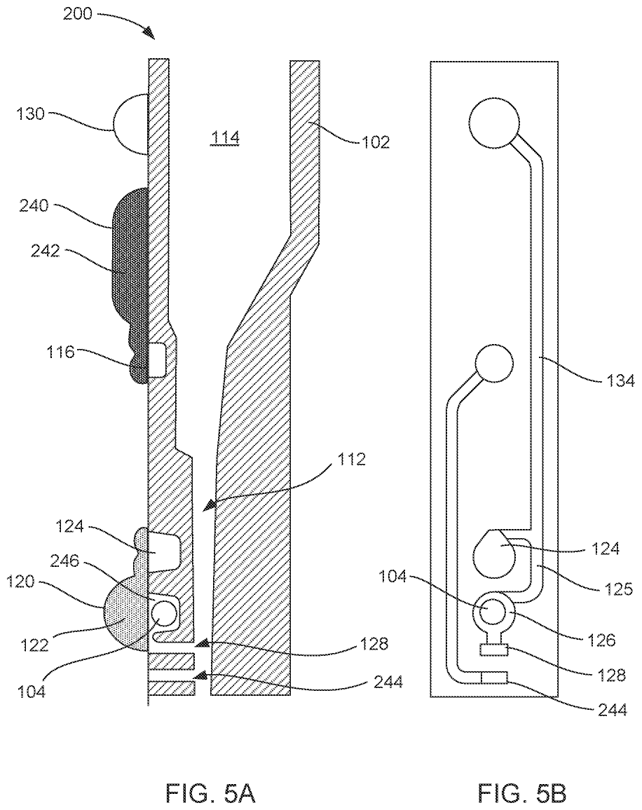

FIGS. 5A-5B show another example fluid processing system 200. As shown in FIG. 5A, this example includes the components of the example in FIGS. 4A-4B, including a solid device body 102, interconnected volumes 110 having a capillary volume 112 and a bulk portion 114, a reservoir 120 of reconstitution buffer 122, a buffer inlet chamber 124, and a reactant chamber 126. FIG. 5B shows a front view of the solid device body without the sealing layer 116 to show the design and placement of the chambers and channels that are formed in the surface of the solid device body. As with the previous example, a fluid channel 125 connects the buffer inlet chamber to the reactant chamber. A dried reactant 104 is held in the reactant chamber, and the reactant chamber is connected to the capillary volume by a reactant injection channel 128. This example also includes a reservoir 240 of wash buffer 242. The wash buffer reservoir is connected to a first fluid injection opening 244 to inject the wash buffer into the interconnected volumes. This example also includes a gas reservoir 130 and a gas channel 134. The gas channel connects to the fluid channel between the buffer inlet chamber and the reactant chamber. This can allow gas from the gas reservoir to push reconstitution buffer and reconstituted reactant out of the reactant chamber and into the capillary volume 112 of the interconnected volumes 110. The gas can bypass any reconstitution buffer that is in the buffer inlet chamber so that this excess reconstitution buffer is not injected into the interconnected volumes.

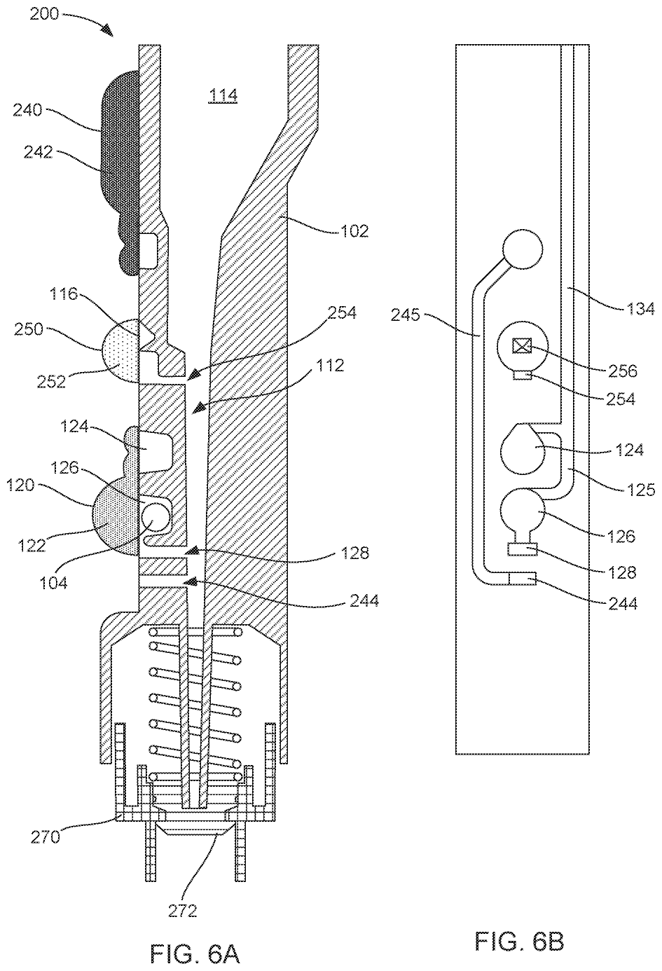

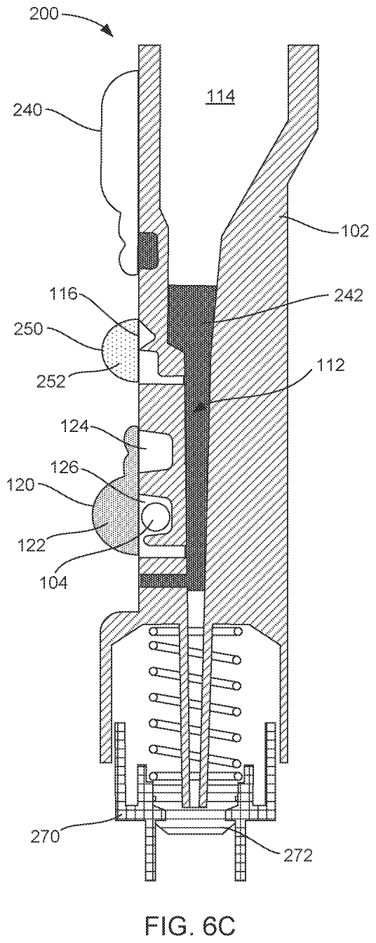

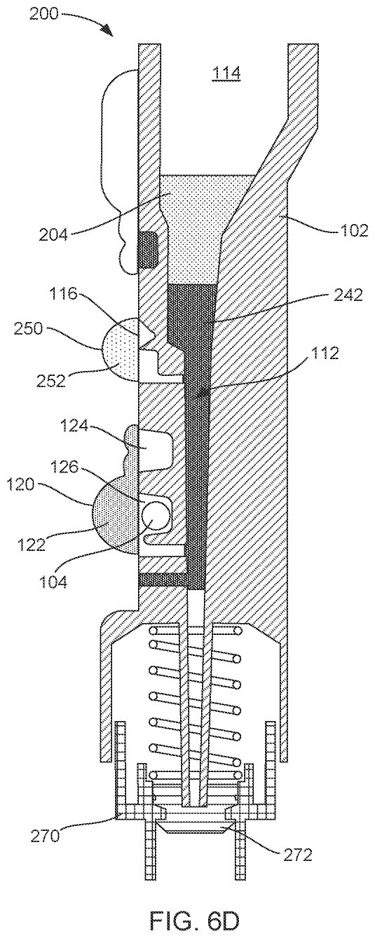

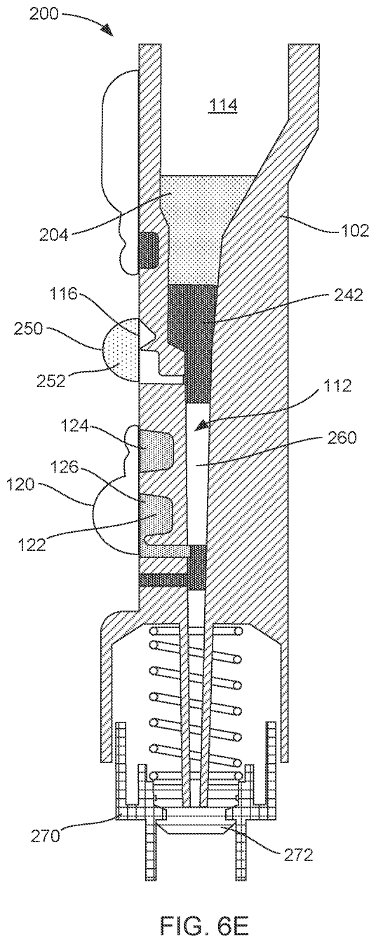

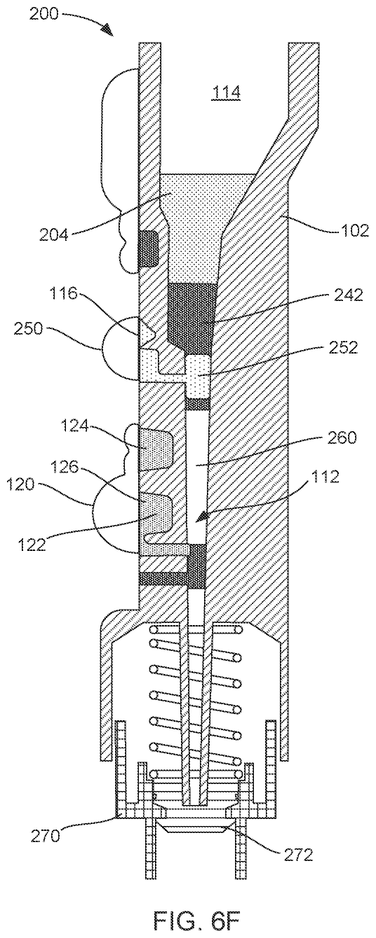

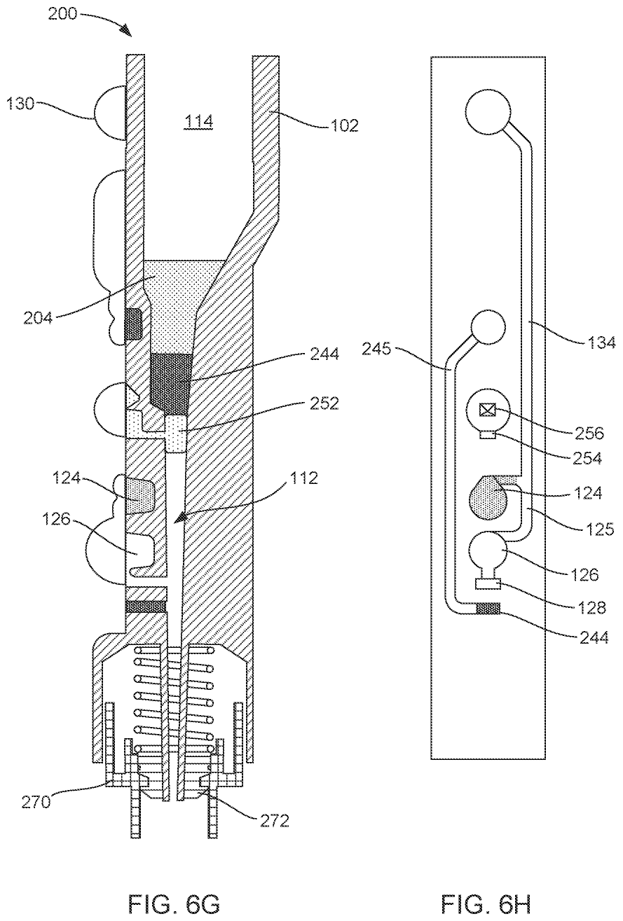

A specific example fluid processing system can be used to prepare samples for a PCR process. In this particular example, the samples can include nucleic acids such as DNA or RNA and the fluid processing system can mix the nucleic acids with reactants such as PCR master mix reactants. An example of this process is depicted in FIGS. 6A-6H. FIG. 6A shows a cross-sectional view of an example fluid processing system 200. The system includes a solid device body 102. Interconnected volumes 110 is formed in the solid device body. In this example, the interconnected volumes can contain a density gradient column. The upper portion of the interconnected volumes in this example is a bulk fluid volume 114, and the lower part is a capillary volume 112. The capillary volume includes the narrower section at the bottom of the column, where capillary forces become more significant. The system also includes a wash buffer reservoir 240 filled with a wash buffer 242. The wash buffer reservoir is a flexible blister located on an exterior surface of the solid device body. The wash buffer can be injected from the wash buffer reservoir into the capillary volume through a first fluid injection opening 244. A non-newtonian plugging fluid reservoir 250 is also located on the surface of the solid device body. This reservoir is filled with a non-newtonian plugging fluid 252 that can be injected into the capillary volume through a plugging fluid injection opening 254. Additionally, a reconstitution buffer reservoir 120 contains a reconstitution buffer 122. The reconstitution buffer reservoir is connected to a reconstitution buffer inlet chamber 124, which is connected to a reactant chamber 126, which is in turn connected to a reactant injection channel 128. A dried reactant 104 is held inside the reactant chamber. The reservoirs of the various fluids are kept sealed with a sealing layer 116. When pressure is applied to the reservoir blisters, the sealing film can rupture to allow the fluids to flow into the interconnected volumes. This particular system also includes a spring loaded cap 270 that holds a flexible septum 272. The flexible septum can seal the bottom opening of the capillary volume. If it is desired to eject fluid out of the bottom of the capillary volume, then the spring loaded cap can be pushed upward and the bottom end of the capillary volume can push through the septum so that the capillary volume is unsealed and fluid can eject out the bottom opening.

To further describe the fluid channels and chambers depicted in the side, cross-sectional view of FIG. 6A, a front view is shown in FIG. 6B. This view shows the surface of the solid device body where the sealing layer is applied. The sealing layer is not shown in FIG. 6B, so that the various chambers and fluid channels are visible. These chambers and fluid channels can be formed as recessed areas in the surface of the solid device body. The sealing layer can be placed over this surface to enclose these chambers and fluid channels. As shown in this view, a wash buffer channel 245 is formed so that the wash buffer can flow from the wash buffer reservoir down to the first fluid injection opening 244, which is the lowest of the fluid injection openings in this example. The plugging fluid injection opening 254 is adjacent to a sharp point 256 formed on the solid device body. The sharp point can puncture the sealing layer to allow non-newtonian plugging fluid to flow into the capillary volume through the plugging fluid injection opening. When the reconstitution buffer reservoir ruptures, the reconstitution buffer can flow into the reconstitution buffer inlet chamber 124. Then, the reconstitution buffer can flow to the reactant chamber 126 through a reconstitution buffer channel 125. In some examples, the volume of reconstitution buffer in the reconstitution buffer reservoir can be such that squeezing the blister reservoir will cause reconstitution buffer to fill the reconstitution buffer inlet chamber and the reactant chamber, but little or no reconstitution buffer will flow into the capillary volume at this time. The reconstitution buffer that is in the reactant chamber can then be pushed into the capillary volume by injecting gas through a gas channel 134.

FIG. 6A and FIG. 6B show the fluid processing system before beginning the example process. The process can begin as shown in FIG. 6C, by pressing on the wash buffer reservoir blister 240 to inject wash buffer 242 into the interconnected volumes 110. The wash buffer is injected in a lower part of the capillary volume 112. From there, the wash buffer fills up the capillary volume and then partially fills the bulk fluid volume 114.

FIG. 6D shows that after introducing the wash buffer 242 into the interconnected volumes 110, a sample fluid 204 is loaded into the interconnected volumes from the top, above the wash buffer. The sample fluid can have a lower density than the wash buffer, so that the sample fluid remains in a layer on top of the wash buffer. Thus, the fluids form a density gradient as explained above. The sample fluid can include a biological component such as nucleic acids (e.g., DNA, RNA), or others. Other materials can also be present, such as lysate and components of lysed cells or viruses. In certain examples, the preparation of the sample fluid can include lysing viruses or cells to extract nucleic acids such as DNA or RNA therefrom. Additionally, the sample fluid in this particular example can include magnetizing particles. The magnetizing particles can be configured to bind or adhere to the biological component. Thus, magnetizing particles having biological components bound thereto can be dispersed in the sample fluid. Although not shown in the figure, the fluid processing device in this example can include a magnet or system of magnets that can be used to move the magnetizing particles downward through the interconnected volumes. Accordingly, the magnet or magnets can be used to draw the magnetizing particles across the interface from the sample fluid into the wash buffer. Then, the magnets can continue to draw the magnetizing particles down through the capillary volume until the magnetizing particles are concentrated at the bottom of the capillary volume. The biological component can remain bound to the magnetizing particles.

In FIG. 6E, the reconstitution buffer reservoir 120 is pressed. This causes the reconstitution buffer 122 to flow into the reconstitution buffer inlet chamber 124 and the reactant chamber 126. The dried reactant that was held in the reactant chamber is dissolved by the reconstitution buffer. In this example, the dried reactant can include PCR master mix reactants. As the reconstitution buffer flows into the reconstitution buffer inlet chamber and the reactant chamber, the gas that was present in these chambers is displaced into the capillary volume 110. This forms a gas gap 260. A small amount of the wash buffer 242 remains at the bottom of the capillary volume. This is because the wash buffer was injected through the first fluid inlet opening, which is located below the second fluid inlet opening. The gas flows in through the second fluid inlet opening to form the gas gap. As explained above, magnetizing particles with biological components bound thereon are concentrated in the wash buffer at the bottom of the capillary volume. Therefore, the biological components remain in the small volume of wash buffer at the bottom of the capillary volume, below the gas gap.

In FIG. 6F, the non-newtonian plugging fluid reservoir 250 is pressed so that the non-newtonian plugging fluid 252 is injected into the capillary volume 112 of the interconnected volumes 110. This forms a plug of non-newtonian plugging fluid that partitions the wash buffer that is above the plug from the gas that is below the plug. As explained above, the non-newtonian fluid can have a sufficient viscosity, after being injected into the capillary volume, that the non-newtonian fluid can prevent the fluid above the plug from flowing down into the capillary volume below the plug. This figure shows the non-newtonian plugging fluid being injected into a region of the capillary volume that contains wash buffer, so that a small amount of wash buffer is beneath the plug between the plug and the gas gap 260. However, in other examples, the non-newtonian plugging fluid may be injected directly into the gas gap. The plug can be in direct contact with gas, e.g., air, on the bottom of the plug and with wash buffer on the top of the plug. In still other examples, a small amount of gas from the gas gap can remain on the top on the top of plug. These results can depend on the size of the gas gap and the placement of the plugging fluid injection opening 254.

FIG. 6G shows that after the plug of non-newtonian plugging fluid 252 has been formed, the reconstitution buffer 122 and the small volume of wash buffer 242 at the bottom of the capillary volume can be ejected from the interconnected volumes. This can be accomplished by uncapping the bottom end of the capillary volume. The spring loaded cap 270 can be pushed upward and the bottom end of the capillary volume can penetrate through the flexible septum 272. Then, a reservoir 130 of gas can be pressed to use gas to force the reconstitution buffer and the wash buffer out of the bottom opening of the capillary volume. The view of the fluid processing system shown in FIG. 6G is extended at the top to show the gas reservoir, which was not shown in the previous figures. To clarify how the gas flows from the gas reservoir, FIG. 6H shows a front view of the surface of the solid device body. The gas flows from the gas reservoir, through a gas channel 134 that connects to the fluid channel 125 between the reconstitution buffer inlet chamber and the reactant chamber. Before pressing the gas reservoir, the reactant chamber and the fluid channel were filled with the reconstitution buffer and the dissolved reactants. When the gas reservoir is pressed, the gas forces the reconstitution buffer and dissolved reactants out into the capillary volume, and then out of the bottom opening of the capillary volume. As shown in FIG. 6H, some of the reconstitution buffer remains in the reconstitution buffer inlet chamber, as this chamber is bypassed by the gas, e.g., air, from the gas reservoir.

The process shown in FIGS. 6A-6H can be used to prepare mixtures of biological components with reactants such as PCR master mix reactants. This mixture can then be further analyzed and processed using appropriate equipment. After the mixture of biological components and PCR master mix reactants is ejected from the bottom of the capillary volume as shown in FIG. 6G, the capillary volume can be re-capped and the fluidic device can be discarded.

Although a specific example process has been shown and described in detail, the fluid processing systems according to the present disclosure can be used to perform a variety of other processes, and the fluid processing systems can include other components besides those described above. In some examples, various fluids can be added to a density gradient column in the fluid processing system. In one example, the density gradient column can include a sample fluid and a wash buffer. In another example, the density gradient column can include a sample fluid, a wash buffer, a gas, and a reconstituted reagent. In yet another example, the density gradient column can include a sample fluid, a lysis buffer, a wash buffer, a gas, and a reconstituted reagent.

The fluid layers of the density gradient column can be formulated to interact with the magnetizing particles that can be present in the sample fluid. The sample fluid layer and other individual fluid layers can have different functions. For example, a fluid layer can include a lysis buffer to lyse cells. In yet other examples, a fluid layer can be a surface binding fluid layer to bind the biological component to the magnetizing particles, a wash fluid layer can trap contaminant from a sample fluid and/or remove contaminant from an exterior surface of the magnetizing particles, a surfactant fluid layer can coat the magnetizing particles, an elution fluid layer can remove the biological component from the magnetizing particles following extraction from the biological sample, a labeling fluid layer can bind labels to the biological component such as a fluorescent label (either attached to the magnetizing particles or unbound thereto), and so on.

In some examples, individual fluid layers can provide sequential processing of a biological sample. For example, individual fluid layers can carry out individual functions, and in many cases, the functions can be coordinated to achieve a specific result. For example, in isolating a biological component found in a cell of a biological sample, sequential fluid layers from top to bottom of a density gradient column can act on the biological sample to lyse cells in a fluid layer, bind a biological component from the lysed biological material to magnetizing particles, wash the magnetizing particles with the biological material bound thereto in a fluid layer, combine biological material with a reagent, and/or elute (or separate) the biological material from the magnetizing particles.

A vertical height of individual fluid layers of the density gradient column can vary. Adjusting a vertical height of an individual fluid layer can affect a residence time of the paramagnetic particles in that fluid layer. The taller the fluid layer, the longer the residence time of the magnetizing particles in the fluid layer. In some examples, all of the fluid layers of the density gradient column can be the same vertical height. In other examples, a vertical height of individual fluid layers in a multi-fluid density gradient column can vary from one fluid layer to the next. In one example, a vertical height of the individual fluid layers can individually range from 10 μm to 50 mm. In another example, a vertical height of the individual fluid layers can individually range from 10 μm to 30 mm, from 25 μm to 1 mm, from 200 μm to 800 μm, or from 1 mm to 50 mm.

The solid device body that defines the interconnected volumes may further include openings, inputs, outputs, and/or ports. For example, the solid device body may include an opening, an input, and/or a port to permit loading of fluids and reagents into the interconnected volumes. For example, a fluid injection opening can permit loading of a sample fluid, a wash buffer, and the like into the bulk fluid volume of the interconnected volumes. In yet other examples, the interconnected volumes can include an input or port to permit loading of fluids and reagents to form the density gradient column. The interconnected volumes may also include outputs. For example, the capillary volume may include a fluidic output that can permit dispensing of a biological component, a biological sample, a fluid, magnetizing particles, or a combination thereof, from the density gradient column. In yet other examples, the solid device body defining the interconnected volumes may include an output for venting gas to relieve pressure along the interconnected volumes.

In certain examples, the wash buffer reservoir can be a flexible fluid-filled blister. In further examples, the wash buffer can be an aqueous solution. For example, a wash buffer can include alcohol (such as ethanol), a binding agent, a salt, a surfactant, a stabilizing agent, or a combination thereof. The amount of wash buffer in the wash buffer reservoir can be sufficient to fill or partially fill the capillary volume and the bulk fluid volume of the interconnected volumes.

A gas reservoir can be sized and shaped to contain a gas, e.g., air, in an amount capable of pushing out the reconstitution buffer and the volume of wash buffer that includes the concentration magnetizing particles at the end of the process described above. The gas reservoir may be located to allow dispensing of gas into the capillary volume of the interconnected volumes. In particular examples, the gas reservoir can be connected by a gas channel to the reactant chamber.

The reactant chamber can be sized and shaped to contain a dry reagent. In one example, the dry reagent reservoir can include the dry reagent. A dry reagent can include PCR master mix reagents, nucleic acid primers, secondary antibodies, polymerases, magnesium salt, bovine serum albumin (BSA), or combinations thereof. In further examples, the reactant chamber can be connected to a reservoir of reconstitution buffer so that the reconstitution buffer can reconstitute the dry reactant. The reactant chamber can also be connected to the capillary volume so that the reconstitution buffer and reconstituted reactant can be injected into the capillary volume.

A reconstitution buffer reservoir can be sized and shaped to contain a reconstitution buffer. In some examples, the reconstitution buffer reservoir can include the reconstitution buffer. In various examples, the reconstitution buffer can be any aqueous solvent. In one example the reconstitution buffer can be water. In further examples, the reconstitution buffer can include additional ingredients such as salts, surfactants, buffering agents to maintain pH, and others. The reconstitution buffer reservoir, as previously discussed, can be arranged to allow dispensing of the reconstitution buffer into a reactant chamber to reconstitute a dry reactant.

Reservoirs may be arranged to allow a fluid or a reagent therein to be individually dispensed into the density gradient column and/or arranged in series to allow a fluid, a reagent, or a combination thereof to be dispensed sequentially or at the same time into the density gradient column.

The magnetizing particles, in further detail, can be in the form of paramagnetic microparticles, superparamagnetic microparticles, diamagnetic microparticles, or a combination thereof, for example. The term “magnetizing particles” is defined herein to include particles or microparticles, e.g., magnetizing microparticles, that may not be magnetic in nature unless and until a magnetic field is introduced at a strength and proximity to cause them to become magnetic. Their magnetic strength can be dependent on the magnetic field applied and may get stronger as the magnetic field is increased, or the magnetizing particles get closer to a magnet applying the magnetic field.

In more specific detail, “paramagnetic microparticles” have these properties, in that they have the ability to increase in magnetism when a magnetic field is present; however, paramagnetic microparticles are not magnetic when a magnetic field is not present. In some examples, the paramagnetic microparticles can exhibit no residual magnetism once the magnetic field is removed. A strength of magnetism of the paramagnetic microparticles can depend on the strength of the magnetic field, the distance between a source of the magnetic field and the paramagnetic microparticles, and a size of the paramagnetic microparticles. As a strength of the magnetic field increases and/or a size of the paramagnetic microparticles increases, the strength of the magnetism of the paramagnetic microparticles increases. As a distance between a source of the magnetic field and the paramagnetic microparticles increases, the strength of the magnetism of the paramagnetic microparticles decreases. “Superparamagnetic microparticles” can act similar to paramagnetic microparticles; however, they can exhibit magnetic susceptibility to a greater extent than paramagnetic microparticles in that the time it takes for them to become magnetized appears to be near zero seconds. “Diamagnetic microparticles,” on the other hand, can display magnetism due to a change in the orbital motion of electrons in the presence of a magnetic field.

The magnetizing particles can be surface-activated to selectively bind with a biological component or can be bound to a biological component from a biological sample. An exterior of the magnetizing particles can be surface-activated with interactive surface groups that can interact with a biological component of a biological sample or may include a covalently attached ligand. In some examples, the ligand can include proteins, antibodies, antigens, nucleic acid primers, nucleic acid probes, amino groups, carboxyl groups, epoxy groups, tosyl groups, sulphydryl groups, or the like. In one example, the ligand can be a nucleic acid probe. The ligand can be selected to correspond with and to bind with the biological component. The ligand may vary based on the type of biological component targeted for isolation from the biological sample. For example, the ligand can include a nucleic acid probe when isolating a biological component that includes a nucleic acid sequence. In another example, the ligand can include an antibody when isolating a biological component that includes antigen. In one example, the magnetizing particles can be surface-activated to bind to nucleic acid such as DNA or RNA. Thus DNA or RNA molecules can be bound to the surface of the magnetizing particles. Commercially available examples of magnetizing particles that are surface-activated include those sold under the trade name DYNABEADS®, available from ThermoFischer Scientific (USA).

In some examples, the magnetizing particles can have an average particle size that can range from 10 nm to 50,000 nm. In yet other examples, the magnetizing particles can have an average particle size that can range from 500 nm to 25,000 nm, from 10 nm to 1,000 nm, from 25,000 nm to 50,000 nm, or from nm to 5,000 nm. The term “average particle size” describes a diameter or average diameter, which may vary, depending upon the morphology of the individual particle. A shape of the magnetizing particles can be spherical, irregular spherical, rounded, semi-rounded, discoidal, angular, sub-angular, cubic, cylindrical, or any combination thereof. In one example, the particles can include spherical particles, irregular spherical particles, or rounded particles. The shape of the magnetizing particles can be spherical and uniform, which can be defined herein as spherical or near-spherical, e.g., having a sphericity of >0.84. Thus, any individual particles having a sphericity of <0.84 are considered non-spherical (irregularly shaped). The particle size of the substantially spherical particle may be provided by its diameter, and the particle size of a non-spherical particle may be provided by its average diameter (e.g., the average of multiple dimensions across the particle) or by an effective diameter, e.g., the diameter of a sphere with the same mass and density as the non-spherical particle.

In an example, the magnetizing particles can be unbound to a biological component when added to the density gradient column. Binding between the magnetizing particles and the biological component of the biological sample can occur within the interconnected volumes. In yet another example, the magnetizing particles and a biological sample including a biological component can be combined before the sample fluid is added to the interconnected volumes.

In some examples, the fluid processing systems can also include a magnet capable of generating a magnetic field. The magnetic field may be turned on and off by introducing electrical current/voltage to the magnet. The magnet can be permanently placed, can be movable along the interconnected volumes, or can be movable in position and/or out of position to effect movement of the magnetizing particles in and through the interconnected volumes. Thus, magnetizing particles can moved through a fluid column, such as a density gradient column, by magnetic manipulation by the magnet.

The magnetizing particles can be magnetized by the magnetic field generated by the magnet. The magnet can also create a force capable of pulling the magnetizing particles through the density gradient column, holding the magnetizing particles at a location along the density gradient column, or a combination thereof. When the magnet is turned off or not in appropriate proximity, the magnetizing particles can reside in a fluid layer until gravity pulls the magnetizing particles through fluid layers of the density gradient column, or they may remain suspended in the fluid layer in which they may reside until the magnetic field is applied thereto. The rate at which gravity pulls the magnetizing particles through fluid layers (or leaves the magnetizing particles within a fluid layer) can be based on a mass of the magnetizing particles, a quantity of the magnetizing particles, and a surface tension at the fluid interface between fluid layers. The magnet can cause the magnetizing particles to move from one fluid layer to another or can increase a rate at which the magnetizing particles pass from one fluid layer into another.

Strength of the magnetic field and the location of the magnet in relation to the magnetizing particles can also affect a rate at which the magnetizing particles move through the density gradient column carried within the interconnected volumes. The further away the magnet and the lower the strength of the magnetic field, the slower the magnetizing particles will move.

In an example, the magnet can be moveable in position, out of position, or at variable positions to effect downward movement, rate of movement, or to promote little to no movement of the magnetizing particles. In another example, the magnet can be positioned adjacent to a side of the multi-fluid density gradient column and can move vertically to cause the magnetizing particles to move therewith. In some examples, the magnet can be a ring magnet that can be placed around a circumference of the interconnected volumes to move the magnetizing particles through the density gradient column. In some examples, a movable magnet(s) can be positioned adjacent to a side of the interconnected volumes that contain the density gradient column, and the magnet(s) in this example are not a ring shape, but rather can be any shape effective for moving magnetizing particles along the density gradient column. In some examples, the magnet can be moved along a side and/or along a bottom of the multi-fluid density gradient column to pull the magnetizing particles in one direction or another. In one example, the magnet can be used to pull the magnetizing particles downwardly through fluid layers of the density gradient column.

In yet other examples, a magnet can be used to concentrate and hold the magnetizing particles near a side wall of the solid device body, e.g., vessel, defining the interconnected volumes. For example, the magnet can concentrate the magnetizing particles near a side wall of the solid device body and heat can be applied to decouple and separate an isolated biological component from the magnetizing particles. The magnet can continue to hold the magnetizing particles while an outlet of the interconnected volumes can be opened thereby allowing dispensing of the isolated biological component from the density gradient column where the biological component is separated from the magnetizing particles.

### Methods of Processing Fluids

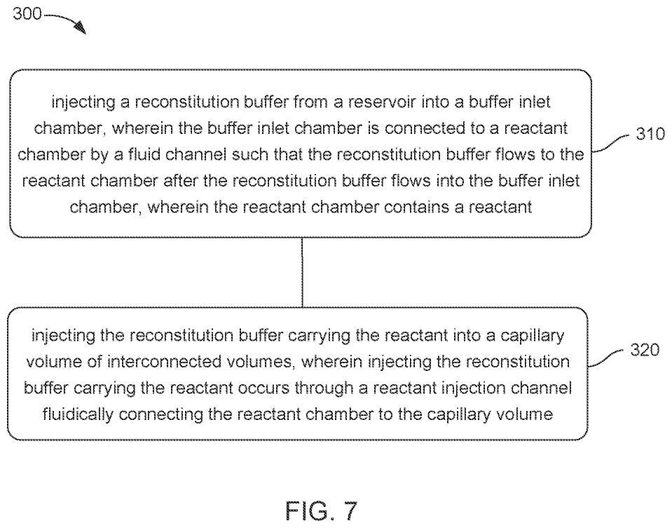

The present disclosure also describes methods of processing fluids. FIG. 7 is a flowchart illustration of one example method 300 of processing fluids. The method can include injecting 300 a reconstitution buffer from a reservoir into a buffer inlet chamber. The buffer inlet chamber in this example can be connected to a reactant chamber by a fluid channel such that the reconstitution buffer flows to the reactant chamber after the reconstitution buffer flows into the buffer inlet chamber, and the reactant chamber in this example can contain a reactant. The method can further include injecting 320 the reconstitution buffer carrying the reactant into a capillary volume of interconnected volumes, wherein injecting the reconstitution buffer carrying the reactant occurs through a reactant injection channel fluidically connecting the reactant chamber to the capillary volume. In one example, the method can also include injecting a wash buffer into the interconnected volumes before injecting the reconstitution buffer into the buffer inlet chamber, and loading a sample fluid into the interconnected volumes above the wash buffer. The sample fluid can include magnetizing particles having a biological component bound thereto, and the sample fluid can have a lower density than the wash buffer. In other examples, the reconstitution buffer can displace the gas from the buffer inlet chamber and the reactant chamber, and the gas can flow into the capillary volume and form a gas gap in the capillary volume.

In further detail, the sample fluid, e.g., biological sample fluid, can be prepared and/or loaded in any of a number manners. For example, the sample fluid may be prepared by combining multiple components within the bulk fluid volume, e.g., combining carrier fluid or buffer with magnetizing particles and the biological component within the bulk fluid volume (which may be or include a portion thereof that acts as a mixing chamber). Thus, the biological component may become associated with the magnetizing particles in the bulk fluid volume, or the biological component may already be associated with the magnetizing particles where they are combined with the fluid carrier or buffer within the bulk fluid volume. Alternatively, the sample fluid may first be prepared in a vial or other vessel outside of the bulk fluid volume, and then the sample fluid can be added into the bulk fluid volume over the wash buffer either before, after, or at the same time that the wash buffer is loaded, e.g., from the bottom up through the capillary volume or also loaded from the top prior to loading the sample fluid. To cite one specific example, a biological sample or specimen may be collected using a swab or other biological sample collection instrument. The biological sample may include the biological component of interest. The released or eluted biological component can then be placed in the carrier fluid or buffer where the biological component is eluted into the carrier fluid or buffer. The biological component can become associated with magnetizing particles in the vial or vessel (or even thereafter in the bulk fluid volume, in some examples). Then, the biological sample fluid that includes the eluted biological component can be loaded into the bulk fluid volume or a mixing chamber fluidically connected to or integrated as part of the bulk fluid volume. Thus, elution may occur outside of the cartridge module before sample input, or within the cartridge module where the carrier fluid or buffer is also loaded.

It is noted that the operations in this method can be performed in any order. The flowchart does not imply a particular order of performing these operations. Additionally, other operations can be performed before, after, or between the operations shown in FIG. 7. For example, a wash buffer can be injected into the interconnected volumes before the reconstitution buffer is injected into the buffer inlet chamber and the reactant chamber. In some examples, a sample fluid can also be loaded into the interconnected volumes before the reconstitution buffer is injected into the buffer inlet chamber and the reactant chamber.

As mentioned above, in some examples the buffer inlet chamber and the reactant chamber contain a volume of gas before the reconstitution buffer is injected. When the reconstitution buffer fills the buffer inlet chamber and the reactant chamber, this gas can be displaced into the capillary volume of the interconnected volumes. Also as mentioned above, in some examples a wash buffer can be injected into the capillary volume before the reconstitution buffer is injected into the buffer inlet chamber. Thus, when the gas is displaced from the buffer inlet chamber and the reactant chamber, the gas can form a gas bubble or gas gap in the capillary volume, displacing some of the wash buffer that is present in the capillary volume. In certain examples, this gas gap can be maintained to provide separation from the wash buffer that is in the bulk fluid volume of the interconnected volumes. After the gas gap has been formed, the reconstitution buffer and the reconstituted reactant can be injected into the capillary volume. For example, the capillary volume can have a bottom opening that can be opened to allow the reconstitution buffer and reactant to be ejected from the system. The gas gap can be carefully maintained during this operation to prevent the wash buffer in the bulk fluid volume from being ejected or from mixing with the reconstitution buffer. In other examples, a non-newtonian plugging fluid can be used in addition to the gas gap to provide a more robust separation, as described in examples above.

In various examples, the methods of processing fluids can include any processes described above. In a specific example, a method of processing fluids can include the process depicted in FIGS. 6A-6H. Any of the devices, materials, and components described above can be used in the methods of processing fluids.

### Definitions

It is noted that, as used in this specification and the appended claims, the singular forms “a,” “an,” and “the” include plural referents unless the context clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and determined based on experience and the associated description herein.

As used herein, the term “interact” or “interaction” as it relates to a surface of the particulate substrates, such as the magnetizing particles, indicates that a chemical, physical, or electrical interaction occurs where a particulate substrate surface property is modified in some manner that is different than may have been present prior to entering the fluid layer, but does not include modification of magnetic properties magnetizing particles as they are influenced by the magnetic field introduced by the magnet. For example, a fluid layer can include a lysis buffer to lyse cells, and cellular components can become bound to or otherwise associated with a surface of the magnetizing particles. Lysing cells in a fluid can modify the fluid sample and thus modify or interact with a surface of magnetizing particles, e.g., the cellular component binds or becomes otherwise associated with a surface of the magnetizing particles. In one example, the association between the biological component and the magnetizing particles (or other particulate substrate) can alternatively include surface adsorption, electrostatic attraction, or some other attraction between the biological component and the surface of the particulate substrate. In yet other examples, a fluid layer that would be considered to interact with the magnetizing particles could be a wash fluid layer to trap contaminates from a sample fluid and/or remove contaminates from an exterior surface of the magnetizing particles, a surfactant fluid layer to coat the magnetizing particles, a dye fluid layer to introduce visible or other markers to the fluid or surface, an elution fluid layer to remove the biological component from the magnetizing particles following extraction from the biological sample, a labeling fluid layer for binding labels to the biological component such as a fluorescent label (either attached to the magnetizing particles or unbound thereto), a reagent fluid layer to prep a biological component for further analysis such as a master mix fluid layer to prep a biological component for PCR, and so on.

As used herein, a plurality of items, structural elements, compositional elements, and/or materials may be presented in a common list for convenience. However, these lists should be construed as though individual members of the list are individually identified as separate and unique members. Thus, no individual member of such list should be construed as a de facto equivalent of any other member of the same list solely based on presentation in a common group without indications to the contrary.

Concentrations, amounts, and other numerical data may be expressed or presented herein in a range format. A range format is used merely for convenience and brevity and thus should be interpreted flexibly to include the numerical values explicitly recited as the limits of the range, and also to include individual numerical values or sub-ranges encompassed within that range as if numerical values and sub-ranges are explicitly recited. As an illustration, a numerical range of “about 1 wt % to about 5 wt %” should be interpreted to include the explicitly recited values of about 1 wt % to about 5 wt %, and also to include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting one numerical value. Furthermore, such an interpretation should apply regardless of the breadth of the range or the characteristics being described.

### EXAMPLE—PREPARATION OF PCR MASTER MIX REACTANTS

A fluid processing system having the design shown in FIG. 6A was prepared using 3D printing. Blister reservoirs were filled with wash buffer, reconstitution buffer, non-newtonian plugging fluid, and air. Colored dyes were added to the wash buffer and reconstitution buffer to allow these fluids to be observed visually in the interconnected volumes. The system was tested by injecting the wash buffer into the interconnected volumes, then pressing the reconstitution buffer blister to cause the reconstitution buffer to flow into the buffer inlet chamber and the reactant chamber. The air displaced from these chambers formed a gas gap in the capillary volume of the interconnected volumes. The non-newtonian plugging fluid was then injected into the capillary volume to form a plug. The bottom of the capillary volume was then uncapped and the air blister was pressed to dispense the reconstitution buffer and the small amount of wash buffer at the bottom of the capillary volume. The process was observed visually and it was determined that the reconstitution buffer did not mix with the wash buffer that was in the interconnected volumes above the non-newtonian fluid plug.

While the present technology has been described with reference to certain examples, various modifications, changes, omissions, and substitutions can be made without departing from the spirit of the disclosure. The disclosure is not limited other than by the scope of the following claims.

1. A fluidic device, comprising:
a plurality of interconnected volumes to receive a density gradient column, the plurality of interconnected volumes including a bulk fluid volume fluidically connected in series with a capillary volume;
a reservoir of a reconstitution buffer positioned outside the plurality of interconnected volumes;
a buffer inlet chamber to receive the constitution buffer from the reservoir of the reconstitution buffer;
a reactant chamber connected to the buffer inlet chamber by a fluid channel, wherein the reactant chamber contains a reactant; and
a reactant injection channel connecting the reactant chamber to the capillary volume to inject the reconstitution buffer and reactant into the capillary volume.

2. The fluidic device of claim 1, wherein the reactant comprises dried PCR master mix reactants and wherein the reconstitution buffer is to reconstitute the dried PCR master mix reactants.

3. The fluidic device of claim 1, wherein the fluid channel connects the reactant chamber to the buffer inlet chamber such that reconstitution buffer flows to the reactant chamber after the reconstitution buffer flows into the buffer inlet chamber.

4. The fluidic device of claim 3, wherein the fluid channel connects to the buffer inlet chamber at a top portion of the buffer inlet chamber such that the buffer inlet chamber fills up to the top portion with the reconstitution buffer before the reconstitution buffer flows through the fluid channel to the reactant chamber.

5. The fluidic device of claim 3, further comprising a gas reservoir and a gas channel connecting the gas reservoir to the fluid channel to inject gas into the fluid channel to push buffer in the fluid channel and buffer in the reactant chamber with the reactant into the capillary volume, while bypassing reconstitution buffer in the buffer inlet chamber.

6. The fluidic device of claim 1, wherein the fluid channel connects to the reactant chamber at a top portion of the reactant chamber and adjacent to a front face of the reactant chamber, wherein the reactant chamber comprises a ramp formed along a wall of the reactant chamber leading from the fluid channel to a back face of the reactant chamber, wherein the ramp forms a sharp corner with the wall to draw reconstitution buffer toward the back face by capillary flow.

7. The fluidic device of claim 1, wherein the buffer inlet chamber and the reactant chamber are formed as depressions in a surface of a solid device body, wherein a sealing layer is placed over the surface of the solid device body to enclose the depressions.

8. The fluidic device of claim 7, wherein the reservoir of reconstitution buffer is a flexible fluid-filled blister separated from the buffer inlet chamber by the sealing layer.

9. The fluidic device of claim 1, further comprising a solid material in the buffer inlet chamber to reduce available volume in the buffer inlet chamber, wherein the solid material is not soluble in the reconstitution buffer.

10. A fluid processing system, comprising:
a plurality of interconnected volumes having a bulk fluid volume fluidically connected in series with capillary volume;
a reservoir of a wash buffer positioned outside the plurality of interconnected volumes;
a first fluid injection opening in the plurality of interconnected volumes to inject the wash buffer into the plurality of interconnected volumes, wherein the first fluid injection opening is connected to the reservoir of the wash buffer;
a reservoir of a reconstitution buffer positioned outside the plurality of interconnected volumes;
a buffer inlet chamber to receive reconstitution buffer from the reservoir of reconstitution buffer;
a reactant chamber connected to the buffer inlet chamber by a fluid channel, wherein the reactant chamber contains a reactant; and
a reactant injection channel connecting the reactant chamber to the capillary volume to inject the reconstitution buffer and reactant into the capillary volume.

11. The fluid processing system of claim 10, wherein the reactant comprises dried PCR master mix reactants, and wherein the reconstitution buffer is to reconstitute the dried PCR master mix reactants.

12. The fluid processing system of claim 10, further comprising a gas reservoir and a gas channel connecting the gas reservoir to the fluid channel to inject gas into the fluid channel to push reconstitution buffer in the fluid channel and reconstitution buffer in the reactant chamber with the reactant into the capillary volume, while bypassing reconstitution buffer in the buffer inlet chamber.

13. A method of processing fluids, comprising:
injecting a reconstitution buffer from a reservoir into a buffer inlet chamber, wherein the buffer inlet chamber is connected to a reactant chamber by a fluid channel such that the reconstitution buffer flows to the reactant chamber after the reconstitution buffer flows into the buffer inlet chamber, wherein the reactant chamber contains a reactant; and
injecting the reconstitution buffer carrying the reactant into a capillary volume of a plurality of interconnected volumes, wherein injecting the reconstitution buffer carrying the reactant occurs through a reactant injection channel fluidically connecting the reactant chamber to the capillary volume.

14. The method of claim 13, further comprising:
injecting a wash buffer into the plurality of interconnected volumes before injecting the reconstitution buffer into the buffer inlet chamber; and
loading a sample fluid into the plurality of interconnected volumes above the wash buffer, wherein the sample fluid includes magnetizing particles having a biological component bound thereto, and wherein the sample fluid has a lower density than the wash buffer.

15. The method of claim 14, wherein the reconstitution buffer displaces gas from the buffer inlet chamber and the reactant chamber, wherein the gas flows into the capillary volume and forms a gas gap in the capillary volume.
